(19) United States
(12) Patent Application Publication
(10) Pub. No.: US 2002/0178069 A1
(43) Pub. Date: Nov. 28, 2002

(54) DYNAMIC QUALITY CONTROL CONDITIONAL PURCHASE OFFER (CPO) MANAGEMENT SYSTEM

(75) Inventors: JAY S. WALKER, RIDGEFIELD, CT (US); T. SCOTT CASE, DARIEN, CT (US); DANIEL E. TEDESCO, NEW CANAAN, CT (US); JAMES A. JORASCH, STAMFORD, CT (US)

Correspondence Address: MORGAN & FINNEGAN, LLP, 345 PARK AVENUE, NEW YORK, NY, 10154

(73) Assignee: WALTER G HANCHUNK

(21) Appl. No.: 09/205,824

(22) Filed: Dec. 4, 1998

Related U.S. Application Data
(63) Continuation-in-part of application No. 08/943,483, filed on Oct. 3, 1997.
(63) Continuation-in-part of application No. 08/923,683, filed on Sep. 4, 1997.
(63) Continuation-in-part of application No. 08/969,875, filed on Nov. 14, 1997, now abandoned.
(63) Continuation-in-part of application No. 08/923,524, filed on Sep. 4, 1997.
(63) Continuation-in-part of application No. 08/889,319, filed on Jul. 8, 1997, now Pat. No. 6,085,169.
(63) Continuation-in-part of application No. 08/707,660, filed on Sep. 4, 1996, now Pat. No. 5,794,207.

(51) Int. Cl. G06F 17/60

(52) U.S. Cl. 705/26

(57) ABSTRACT

A dynamic quality control conditional purchase offer (CPO) management system is disclosed for processing CPOs received from one or more buyers for a product. The dynamic quality control CPO management system processes each received CPO to determine whether one or more sellers are willing to accept a given CPO. The dynamic quality control CPO management system initially evaluates received CPOs to identify CPOs which are not statistically likely to be accepted by sellers. If a received CPO is statistically likely to be accepted, the dynamic quality control CPO management system can submit the CPO for further consideration by sellers to determine if any seller actually accepts the CPO, or provisionally accept the CPO. If a received CPO is statistically likely to be rejected, the dynamic quality control CPO management system can (i) instantly reject the CPO, (ii) encourage the buyer to modify the CPO, so that the modified CPO is more likely to be accepted by a seller, or (iii) subsidize the CPO in order to make it more likely to be accepted. A historical conditional purchase offer database is used to track and store information on CPOs that have been previously processed by the dynamic quality control CPO management system.

This application is a continuation-in-part of U.S. patent application Ser. No. 08/943,483 filed Oct. 3, 1997, which is a continuation-in-part of U.S. patent application Ser. No. 08/923,683 filed Sep. 4, 1997, and is further a continuation-in-part of U.S. patent application Ser. No. 08/969,875, filed Nov. 14, 1997, which is a continuation-in-part of U.S. patent application Ser. No. 08/923,524 filed Sep. 4, 1997, which is a continuation-in-part of U.S. patent application Ser. No. 08/889,319, filed Jul. 8, 1997, which is a continuation-in-part of U.S. patent application Ser. No. 08/707,660, filed Sep. 4, 1996, now issued U.S. Pat. No. 5,794,207, each of which is incorporated in its entirety by reference herein.

### FIELD OF THE INVENTION

The present invention relates generally to a system for processing the sale of products and, more particularly, to methods and apparatus for processing the sale of products, such as airline tickets and automobiles, to buyers who have submitted a purchase offer for the purchase of such products.

### BACKGROUND OF THE INVENTION

Most systems for processing the sale of products are seller-driven, whereby the seller prices, packages, configures and offers the product for sale, and the buyer decides whether or not to accept the seller's offer. In a buyer-driven system, however, the buyer dictates the terms of the offer and one or more sellers decide whether or not to accept the offer. A “help wanted” advertisement, for example, is a buyer-driven inquiry since the employer is looking to locate and buy the services of a qualified employee. The inquiry is advertised to a large number of potential employees, who may respond by submitting their resumes to the prospective employer.

Priceline.com, Incorporated of Stamford, Conn. is a merchant that has successfully implemented a buyer-driven system for the sale of products, such as airline tickets and automobiles. Priceline.com utilizes a Conditional Purchase Offer (CPO) Management System, described in the parent and grandparent applications to the present invention, that processes conditional purchase offers received from individual buyers. These conditional purchase offers contain one or more buyer-defined conditions for the purchase of goods or services, at a buyer-defined price. They are typically guaranteed by a general-purpose account, such as a debit or credit account, and thereby provide sellers with a mechanism for enforcing any agreement that may be reached with the buyer. The conditional purchase offers are provided by the CPO Management System to sellers, either directly or using seller-supplied rates, for individual sellers to either accept or reject. If a seller accepts a conditional purchase offer, the CPO Management System binds the buyer on behalf of the accepting seller, to form a legally binding contract.

Thus, the CPO Management System empowers individual buyers to obtain goods and services at a price set by the buyer. The CPO Management System provides numerous commercial advantages to sellers as well. For example, the CPO Management System permits individual sellers to effectively sell excess capacity when actual demand fails to meet forecasted demand. In particular, the CPO Management System provides an effective mechanism for sellers to be confident that if they accept a buyer's offer, the buyer will purchase the requested goods or services at the agreed-upon price, and not just use the information to ascertain the seller's underlying level of price flexibility, which, if known to a seller's competitors or customers, could impact the seller's overall revenue structure.

For many transactions, the CPO Management System will effectively complete transactions in this manner. Invariably, however, a percentage of buyers will submit purchase offers that are not acceptable to any seller, typically because the price offered by the buyer is too low. The success of the CPO Management System depends, at least in part, on its utilization by a large number of both buyers and sellers. Specifically, buyers are incented to submit conditional purchase offers if they know the conditional purchase offers will be reviewed by a large number of potential sellers. Sellers are incented to consider conditional purchase offers if they can expect a large number of attractive offers. In addition to being a lost business opportunity, unacceptable conditional purchase offers require buyers and sellers to spend time submitting and reviewing such conditional purchase offers. Thus, buyers and sellers alike may be frustrated and discouraged from utilizing the CPO Management System, if the acceptance rate for submitted conditional purchase offers does not meet satisfactory levels.

Buyers and sellers alike would benefit if unacceptable conditional purchase offers could be identified as early as possible in the conditional purchase offer process. If unacceptable conditional purchase offers are identified early enough, a buyer can be provided the opportunity to revise and resubmit the conditional purchase offer to a modified conditional purchase offer that is more likely to be accepted. In addition, buyers can avoid the frustration that accompanies a delayed rejection or expiration of an unacceptable conditional purchase offer. Likewise, some sellers may benefit from not having to review unacceptable conditional purchase offers. Consequently, a need exists for a system that reviews conditional purchase offers and identifies conditional purchase offers that are unlikely to be accepted.

### SUMMARY OF THE INVENTION

A dynamic quality control conditional purchase offer (CPO) management system, hereinafter referred to as the CPO system, is disclosed for processing CPOs received from one or more buyers for a product. The CPO system processes each received CPO to determine whether one or more sellers are willing to accept a given CPO. As used herein, a CPO is an offer containing one or more conditions submitted by a buyer for the purchase of a product at a buyer-defined price.

According to one aspect of the invention, the CPO system initially evaluates received CPOs to identify those CPOs that are unlikely to be accepted by sellers. If the CPO system determines that a received CPO is statistically likely to be accepted, the CPO system can submit the CPO for further consideration by sellers to determine if any seller actually accepts the CPO, or the CPO system can provisionally accept the CPO itself If the CPO system determines that a received CPO is statistically likely to be rejected, the CPO system can (i) instantly reject the CPO, (ii) encourage the buyer to modify the CPO, so that the modified CPO is more likely to be accepted by a seller, and/or (iii) subsidize the CPO in order to make it more likely to be accepted.

A historical conditional purchase offer database is used to track and store information on CPOs that have been previously processed by the CPO system. The recorded historical information is used to statistically determine whether a received CPO is likely to be accepted by a seller. The historical database stores the conditions and offer price associated with processed CPOs, as well as the corresponding outcome (accepted, rejected or expired). In an alternate embodiment, historical retail pricing information is utilized to determine whether a received CPO is likely to be accepted by a seller

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating a dynamic quality control conditional purchase offer (CPO) management system in accordance with the present invention;

FIG. 2 is a schematic block diagram of the exemplary central controller of FIG. 1;

FIG. 3 illustrates a sample table from the seller database of FIG. 2;

FIG. 4 illustrates a sample table from the buyer offer database of FIG. 2;

FIG. 5 illustrates a sample table from the offer database of FIG. 2;

FIG. 6 illustrates a sample table from the seller rules database of FIG. 2;

FIGS. 7A and 7B together comprise a flowchart describing an exemplary CPO pre-processing method implemented by the central controller of FIG. 2;

FIG. 8 is a flowchart describing an exemplary CPO evaluation process implemented by the central controller of FIG. 2; and

FIG. 9 is a flowchart describing an exemplary rules evaluation subroutine implemented by the central controller of FIG. 2.

### DETAILED DESCRIPTION

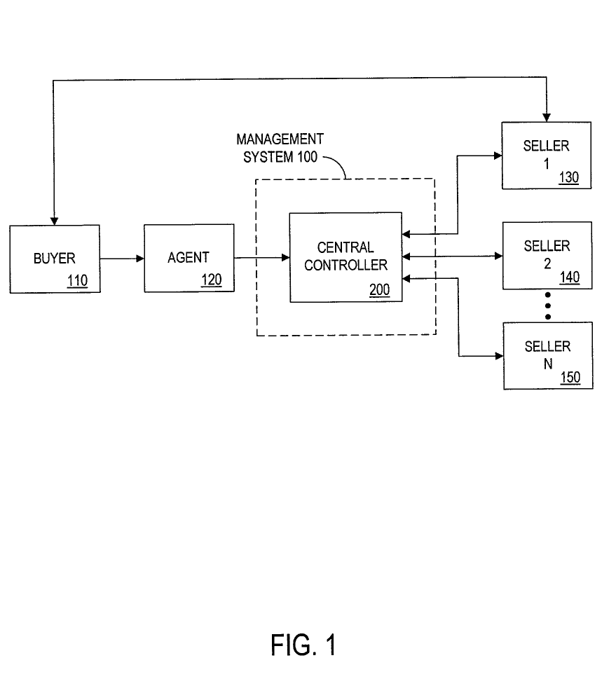

FIG. 1 shows a dynamic quality control conditional purchase offer (CPO) management system 100, hereinafter referred to as the CPO system 100, for receiving and processing CPOs for one or more goods or services, from one or more buyers 110 or agents 120 (on behalf of buyers 110). The CPO system 100 determines whether one or more sellers, such as sellers 130, 140, 150 are willing to accept a given CPO. As discussed further below, if a seller accepts a given CPO, the CPO system 100 is operated in one embodiment to bind the buyer on behalf of the accepting seller, to form a legally binding contract.

### CPO TERMINOLOGY

As used herein, the following terms are defined to mean:

Agency-Based Seller—A seller who has delegated authority to the dynamic quality control CPO management system operator to accept or reject a given CPO using seller-defined CPO Rules.

Broadcast-Based Seller—A seller who has received a CPO from the dynamic quality control CPO management system (directly or by, for example, access to an electronic posting) for evaluation.

Conditional Purchase Offer (CPO)—An offer containing one or more conditions submitted by a buyer for the purchase of goods and/or services at a buyer-defined price.

Binding Conditional Purchase Offer (Binding CPO)—A binding offer containing one or more conditions submitted by a buyer for the purchase of goods and/or services at a buyer-defined price. As compared to a CPO, a Binding CPO includes a payment guarantee, for example with a General Purpose Account, and authorization to debit the Account upon acceptance of the CPO.

Conditional Purchase Offer (CPO) Rule—A restriction defined by an Agency-Based Seller under which the operator of the dynamic quality control CPO management system may act as an agent to determine whether to fill a CPO for that Agency-Based Seller.

CPO Management System—One or more controllers that receive and process CPOs for one or more goods or services, from one or more buyers, to determine if one or more sellers (Agency-Based or Broadcast-Base Sellers) are willing to accept a CPO.

General Purpose Account—Any account from which payment can be made, including a credit or debit account.

According to a feature of the present invention, the CPO system 100 evaluates received CPOs to identify CPOs which are not statistically likely to be accepted by sellers. One or more historical databases are used to track and store information on CPOs that have been previously processed by the CPO system 100. The CPO system 100 uses the recorded historical information to statistically determine whether a received CPO is likely to be accepted by a seller. As discussed further below, the historical database(s) stores the conditions and offer price associated with processed CPOs, as well as the corresponding outcome (accepted, rejected or expired). Thus, as the historical offer database is updated over time with each new processed CPO, the recorded information becomes more statistically reliable. In an alternate embodiment, the historical database stores information on historical retail prices, such as historical published fares or a historical fare database in an airline implementation.

If the CPO system 100 determines that a received CPO is statistically likely to be accepted, the CPO system 100 can submit the CPO for further consideration by sellers to determine if any seller actually accepts the CPO, or the CPO system 100 can provisionally accept the CPO itself In the event of a provisional acceptance, the operator of the CPO system 100 takes the economic risk of guaranteeing that the offer will be accepted by a seller. If, on the other hand, the CPO system 100 determines that a received CPO is statistically likely to be rejected, the CPO system 100 can (i) instantly reject the CPO, (ii) encourage the buyer to modify the CPO, so that the modified CPO is more likely to be accepted by a seller, and/or (iii) subsidize the CPO in order to make it more likely to be accepted.

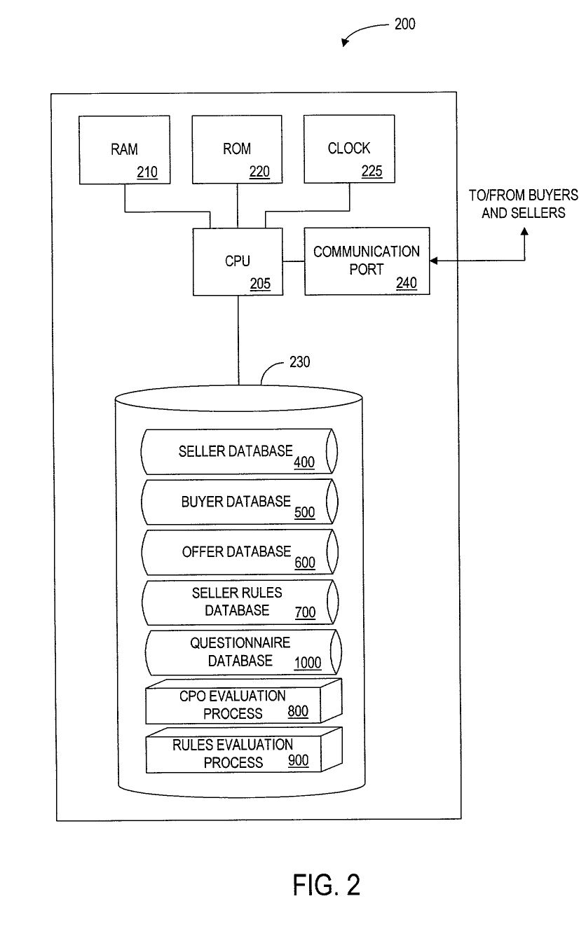

As shown in FIG. 1, the CPO system 100 includes a central controller 200, discussed further below in conjunction with FIG. 2. The CPO system 100 may provide a given CPO to selected sellers 130, 140, 150 based on predefined screening criteria, so that sellers only obtain CPOs that they may be interested in or are authorized to screen. Alternatively, the CPO system 100 may provide all CPOs to all sellers for screening.

As discussed further below, each buyer 110 contacts the CPO system 100, for example, by means of telephone, facsimile, online access (i.e. the Internet), electronic mail, in-person contact or through an agent, and provides the CPO system 100 with the terms of the buyer's CPO. It is noted that each buyer 110 and seller 130, 140, 150 may employ a general-purpose computer for communicating with the CPO system 100. The general-purpose computer may be comprised of a processing unit, a modem, memory means and any software required to communicate with the CPO system 100.

The CPO system 100, as well as any general-purpose computers utilized by buyers 110 or sellers 130, 140, 140 (collectively, the “nodes”) transmit digitally encoded data and other information between one another. The communication links between the nodes can comprise, for example, a cable, fiber or wireless link on which electronic signals can propagate.

### AGENCY AND BROADCAST-BASED SELLERS

According to one feature of the present invention, the CPO system 100 provides an optional agency feature that permits the CPO system 100 to accept or reject a given CPO on behalf of certain agency-based sellers 130 who have delegated such authority to the CPO system 100. Thus, the CPO system 100 (i) evaluates CPOs on behalf of certain agency-based sellers 130 who have delegated authority to the CPO system 100 to accept or reject a given CPO, and (ii) permits broadcast-based sellers, such as sellers 140, 150 to evaluate CPOs independently.

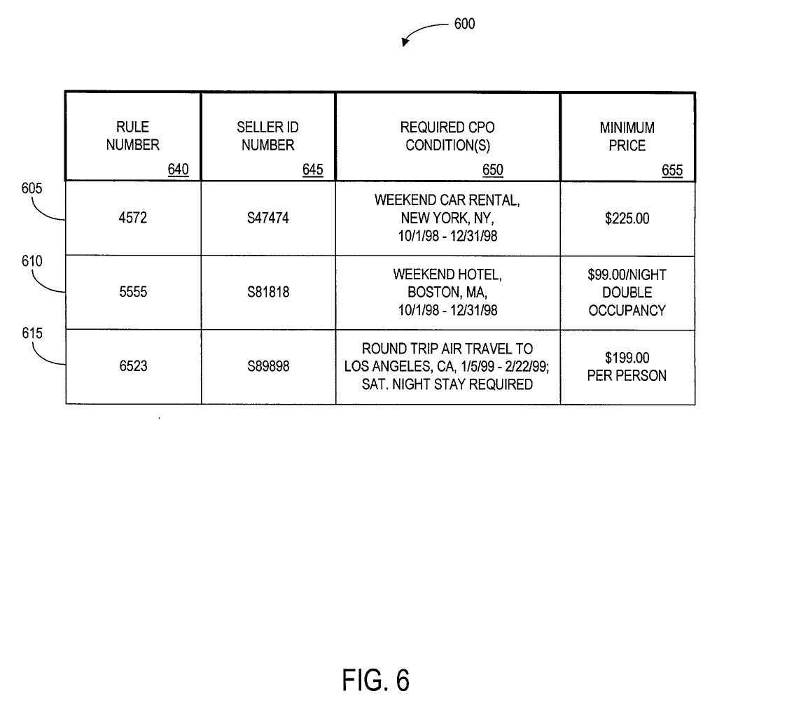

Thus, the CPO system 100 can optionally provide one or more CPOs to each broadcast-based seller 140, 150, for the seller 140, 150 to independently determine whether or not to accept a given CPO. It is noted that the CPO system 100 can provide a CPO to each appropriate broadcast-based seller 140, 150, for example, by means of a broadcast transmission, or by means of posting the CPO, for example, on an electronic bulletin board or secure web site accessible by each broadcast-based seller 140, 150. Alternatively, the CPO system 100 can evaluate one or more CPOs against a number of CPO rules defined by one or more agency-based sellers 130, to decide on behalf of an agency-based seller 130 whether to accept or reject a given CPO. An illustrative set of CPO rules for one illustrative agency-based seller 130 is set forth in FIG. 6. Thus, the CPO system 100 can determine if one or more sellers 140, 150 accepts a given CPO by providing the CPO to each seller 140, 150 and receiving an acceptance or rejection, or by applying the CPO to the CPO rules to render a decision to either accept, reject or counter a CPO on behalf of a particular seller 130.

As discussed further below, a CPO rule is a set of restrictions defined by a given agency-based seller 130 under which the seller 130 is willing to accept a CPO. For a more detailed discussion of CPO rules, the manner in which they are generated, and related security issues, see U.S. patent application Ser. No. 08/889,319, entitled Conditional Purchase Offer Management System, filed Jul. 8, 1997, referenced herein above.

A CPO can optionally contain one or more buyer-defined variable or flexible conditions, typically specified using a range. For example, the variable condition may be a date range within which the product may be delivered by the seller. Other variable conditions might include a price range, a performance range or a quality range. The seller may then choose a product to fill the buyer's flexible condition within the specified range. Such a variable condition may provide substantial assistance to the seller in filling the buyer's CPO. For example, with respect to an airline ticket, the seller may be able to be meet a buyer's specified price if the CPO permits the seller to select a flight within a range of times or days.

It is desirable that in one embodiment the present invention prevents buyers from repetitively querying, or “pinging,” the CPO system 100 to determine the underlying price flexibility of the sellers. Such pinging might result in potential damage to the seller's price margins and profitability. As mentioned above, a binding CPO discourages pinging by ensuring that if an offer is accepted, the buyer must actually purchase the product. Another method of discouraging pinging includes preventing buyers from submitting repetitive, similar offers. For example, repetitive CPOs that change only the offer price in an effort to determine price flexibility may be blocked by the system. In one embodiment, subsequent CPOs by the same buyer are accepted by the CPO system 100 only if there is some substantial change to the buyer specifications that would result in the purchase of an essentially different product. For example, with respect to the sale of airline tickets, subsequent CPOs may be accepted for processing only if there is a significant change in the itinerary. Yet another method for discouraging pinging is to require a payment or fee for each submission of a CPO.

In one embodiment of the invention, seller identities are maintained anonymous within the CPO system 100 until a CPO is accepted. Such seller anonymity, by itself and in combination with the discouragement of price pinging discussed above, enables sellers to participate in the CPO process without fear of undercutting their published price structures and losing their regular customer base. For example, most retailers have published product prices, and loyal customers who willingly pay those prices. Participating in the CPO system 100 enables a seller to discount those products, potentially below its published prices, to fill offers from buyers who might not otherwise pay published prices. With anonymity, these sellers can more freely participate in the CPO process with less fear of losing their regular customers and undercutting their published price structure.

FIG. 2 is a block diagram showing the architecture of an illustrative central controller 200. The central controller 200 includes certain standard hardware components, such as a central processing unit (CPU) 205, a random access memory (RAM) 210, a read only memory (ROM) 220, a clock 225, a data storage device 230, and a communications port 240. The CPU 205 may be linked to each of the other listed elements, either by means of a shared data bus, or dedicated connections, as shown in FIG. 2. The communications port 240 connects the central controller 200 to each buyer 110 and seller 130 and optionally to remote credit processing servers. The communications port 240 may include multiple communication channels for simultaneously establishing a plurality of connections.

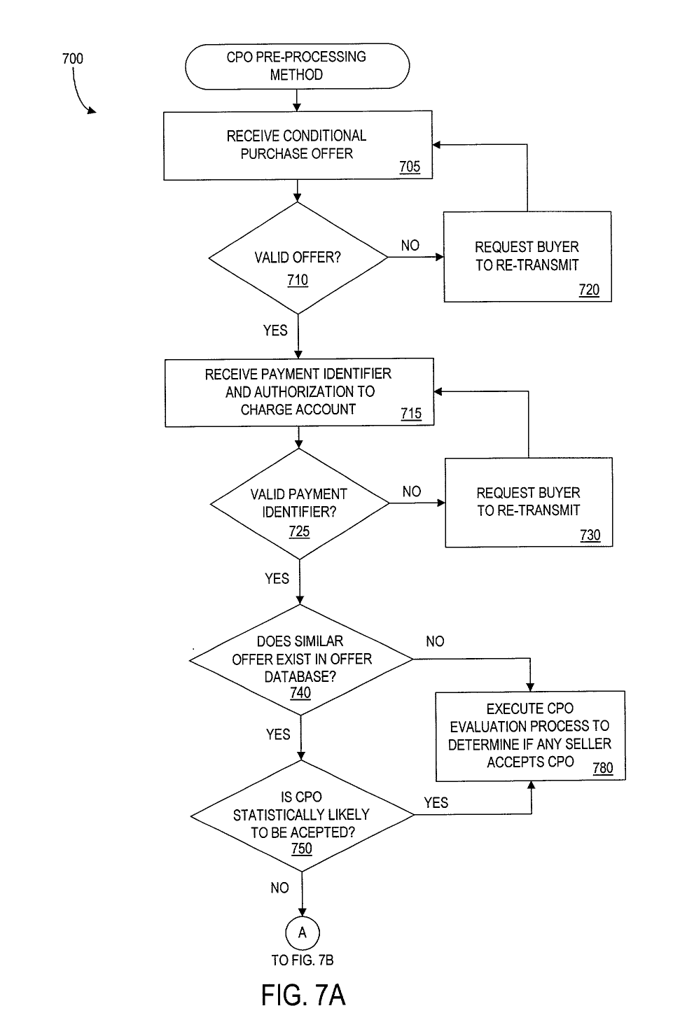

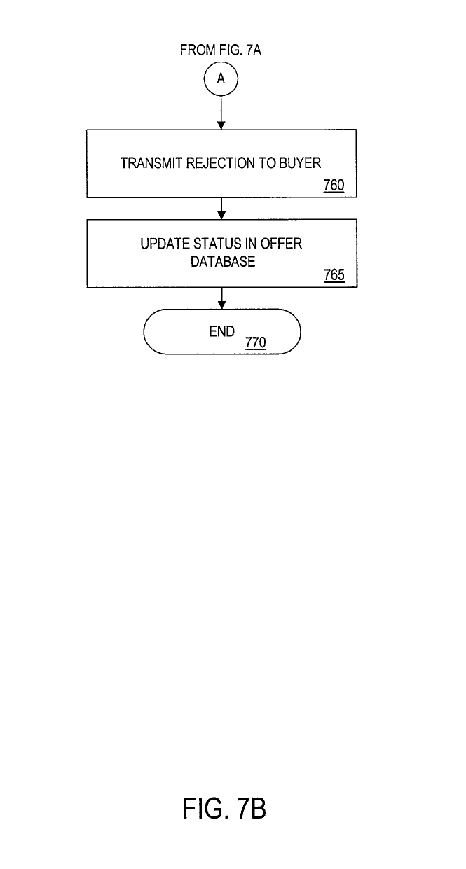

The ROM 220 and/or data storage device 230 are operable to store one or more instructions, discussed further below in conjunction with FIGS. 7 through 9, which the CPU 205 is operable to retrieve, interpret and execute. For example, the ROM 220 and/or data storage device 230 may store processes to accomplish the transfer of required payments, charges and debits, between the sellers 130 and buyers 110. The processing of such accounting transactions may be secured in a conventional manner, for example, using well-known cryptographic techniques.

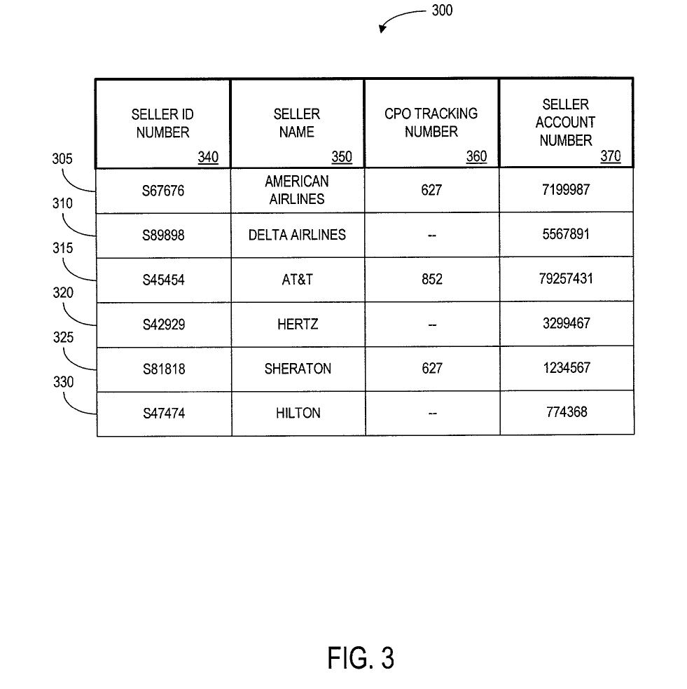

As discussed further below in conjunction with FIGS. 3 through 6, respectively, the data storage device 230 includes a seller database 300, a buyer database 400, an offer database 500 and a seller rules database 600. The seller database 300 stores information on each seller 130, 140, 150 which is registered with the CPO system 100 to sell products, i.e., goods and/or services to CPO buyers, including contact information. The buyer database 400 stores information on each buyer transacting business through the CPO system 100, including identification information and billing information, such as a credit card number or another general-purpose account identifier. The offer database 500 contains a record of each CPO processed by the CPO system 100, including the conditions associated with the CPO and the associated status. The historical information recorded in the offer database 500 is used, among other things, to determine whether a received CPO is likely to be accepted by a seller. The seller rules database 600 maintains the CPO rules for one or more agency-based sellers 130.

In addition, the data storage device 230 includes a CPO pre-processing method 700, a CPO evaluation process 800 and a rules evaluation subroutine 900, discussed further below in conjunction with FIGS. 7 through 9, respectively. Generally, the CPO pre-processing method 700 receives each CPO from a buyer 110 and determines if the CPO is statistically likely to be accepted by a seller. The CPO evaluation process 800 provides each CPO that remains after pre-processing to the appropriate broadcast-based sellers and evaluates each CPO against the appropriate rules of each agency-based seller, and determines whether any sellers 130, 140, 150 accept the CPO. The rules evaluation subroutine 900 is a subroutine executed by the CPO evaluation process 800, which receives a CPO and compares the CPO against the rules of one or more agency-based sellers to generate a response on behalf of the sellers to the given CPO.

### DATABASES

FIG. 3 illustrates an exemplary seller database 300 that stores information on each seller which is registered with the CPO system 100 to sell products, i.e., goods and/or services to CPO buyers. The seller database 300 maintains a plurality of records, such as records 305-330, each associated with a different seller. For each seller identifier listed in field 340, the seller database 300 includes the corresponding seller name in field 350, as well as a CPO tracking number and seller account number in fields 360 and 370, respectively. It is noted that the seller identifier stored in field 340 may be utilized, for example, to index the offer database 500 to identify CPOs which have been accepted by the corresponding seller.

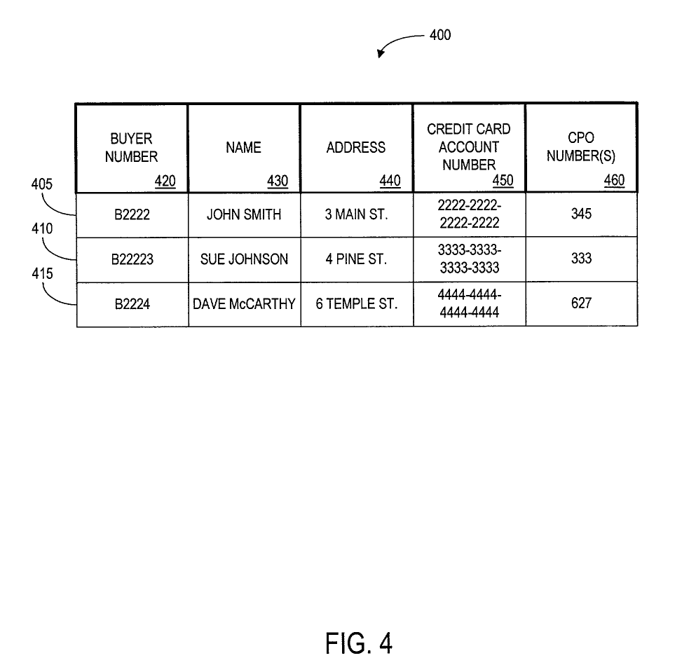

FIG. 4 illustrates an exemplary buyer database 400 that stores information on each buyer transacting business through the CPO system 100, including biographical information and billing information, such as a credit card number or another general purpose account identifier. The buyer database 400 maintains a plurality of records, such as records 405-415, each associated with a different buyer. For each buyer identifier in field 420, the buyer database 400 includes the corresponding buyer name and address in fields 430 and 440, respectively, and credit card account number in field 450. In addition, the buyer database 400 includes the CPO tracking numbers associated with the buyer in field 460. The buyer identifier stored in field 420 may be utilized, for example, to index a historical database (not shown) of previous purchases and CPOs associated with the buyer.

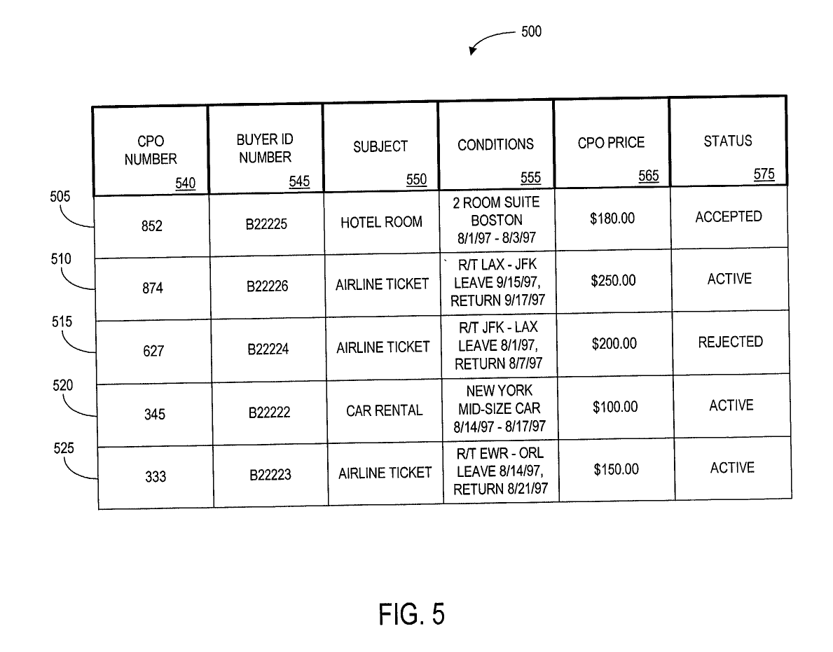

FIG. 5 illustrates an offer database 500 that contains a record of each CPO processed by the CPO system 100, including the subject and conditions of each CPO and the associated status. The offer database 500 maintains a plurality of records, such as records 505-525, each associated with a different CPO. For each CPO number listed in field 540, the offer database 500 includes an identifier of the buyer associated with the CPO in field 545, as well as the subject and conditions of the CPO in fields 550 and 555, respectively. In addition, the offer database 500 may record the buyer-specified CPO price and current status in fields 565 and 575, respectively. The current status options recorded in field 575 include, for example, pending, accepted, rejected or expired. Thus, the historical offer database stores the conditions and offer price associated with processed CPOs, as well as the corresponding outcome (accepted, rejected or expired). The historical information recorded in the offer database 500 is used, among other things, to determine whether a received CPO is likely to be accepted by a seller.

FIG. 6 illustrates a seller rules database 600 that maintains the CPO rules for one or more agency-based sellers. The seller rules database 600 maintains a plurality of records, such as records 605-615, each associated with a different CPO rule. For each CPO rule identified in field 640, the seller rules database 600 identifies the corresponding seller in field 645, as well as the minimum required conditions and price for a CPO to be accepted on behalf of the corresponding seller in fields 650 and 655, respectively.

### PROCESSES

As discussed above, the central controller 200 can execute a CPO pre-processing method 700 to receive each CPO from a buyer 110 and determine if the CPO is statistically likely to be accepted by a seller. While CPOs may be binding or nonbinding in nature, the present embodiment is described with respect to a binding CPO. The processing of a nonbinding CPO is substantially identical, with the exception that authorization to charge the buyer credit card account (or another general purpose account) may be obtained after a seller acceptance of the CPO is identified. Alternatively, the process may be identical with the buyer being given the option to renege after the CPO is accepted by a seller.

As shown in FIG. 7, the CPO pre-processing method 700 initially receives a CPO from a buyer 110 during step 705. A test is then performed during step 710 to determine if the CPO is valid. For example, the test performed during step 710 may determine if the buyer has specified each of the relevant conditions for a given product category.

If it is determined during step 710 that the terms of the CPO are not valid, then the buyer is requested to retransmit the CPO during step 720 and program control returns to step 705. If, however, it is determined during step 710 that the terms of the CPO are valid, then an identifier of a general purpose account, such as a credit or debit card account from which funds may be paid, and an authorization to charge such general purpose account, are received during step 715. In this manner, the CPO is guaranteed with a general-purpose account, for example, using a line of credit on a credit card account. Appropriate legal language is may be displayed or read to the buyer at the time the CPO is received, to form a binding CPO.

A test is then performed during step 725 to determine if the payment identifier is valid. For example, the payment identifier may be transmitted to a remote credit card server for pre-authorization or the like. If it is determined during step 725 that the payment identifier is not valid, then the buyer is requested to retransmit a different payment identifier during step 730 and program control returns to step 715. If, however, it is determined during step 725 that the payment identifier is valid, then the CPO system 100 performs a further test during step 740 to determine if a similar offer exists in the offer database 500. Similar CPOs can be identified, for example, with well-known fuzzy logic techniques or with one or more thresholds that allow for a certain margin of departure from the conditions of the CPO, such as all CPOs for travel within a predefined period of time of the travel dates for a travel-related CPO.

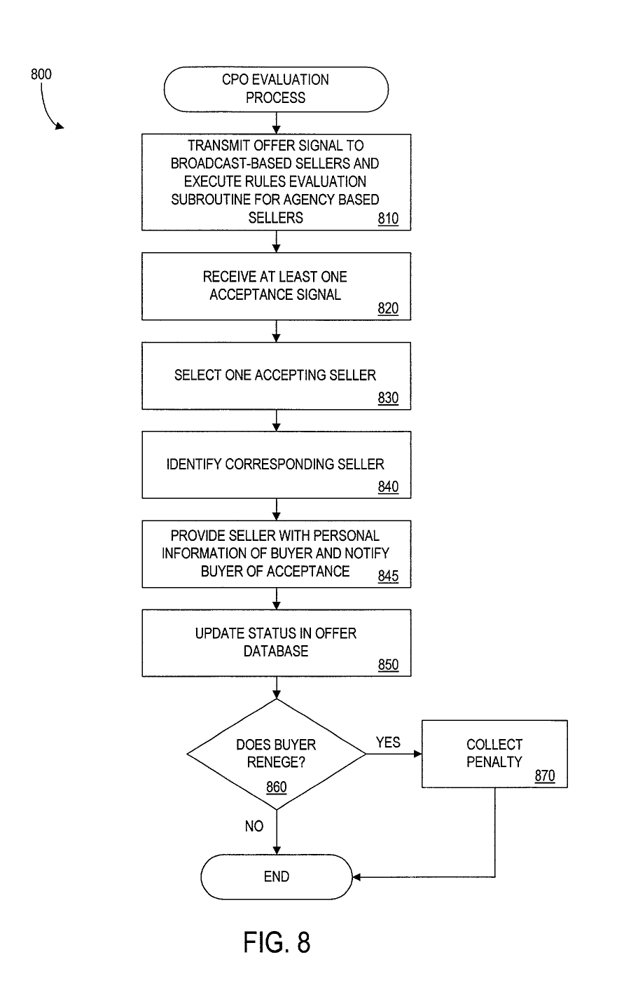

If it is determined during step 740 that a similar offer does not exist in the offer database 500, then no historical information is available to predict the statistical likelihood of acceptance, and the CPO is processed in a conventional manner during step 780. The CPO evaluation process 800 (FIG. 8) is executed during step 780 to determine if any seller is willing to accept the CPO.

If, however, it is determined during step 740 that one or more similar offers exist in the offer database 500, then a further test is performed during step 750 to determine if the CPO is statistically likely to be accepted. In one embodiment, the similar offers identified during step 740 are reviewed during step 750 to determine whether previously processed CPOs containing similar conditions and offer prices were accepted or rejected. In a further variation, the received CPO can be compared during step 750 against historical or published retail pricing data to determine if the received CPO is likely to be accepted. As previously indicated, the CPO system 100 prescreens the terms of each CPO to determine the likelihood that the CPO will be accepted by a seller.

If it is determined during step 750 that the CPO is likely to be accepted then program control proceeds to step 780 to determine if any seller actually accepts the CPO, in the manner described above. If, however, it is determined during step 750 that the CPO is not likely to be accepted then a rejection message is transmitted to the buyer during step 760 and the offer database 500 is updated during step 765. In an alternate embodiment, the buyer is requested to transmit different CPO terms. Program control terminates during step 770.

It is noted that in addition to screening for statistical likelihood of acceptance during step 750, one or more additional or alternative filtering criteria can be applied to received CPOs before they are evaluated by or on behalf of sellers. For example, a filter can be applied to ensure that the CPO system 100 earns a sufficient margin on the CPO. In an alternate implementation, the ability to identify offers that are statistically likely to be accepted is based on a demand forecast, such as a central reservation system (CRS) or proprietary airline reservation systems (ARSs) of each airline in an airline implementation, as well as on historical acceptance information. The demand forecast can be based, for example, on historical or seasonal demand data, or on anticipated upcoming events or weather conditions. Thus, the thresholds utilized to determine whether a CPO is statistically likely to be accepted may be dynamically adjusted in accordance with changing market conditions.

In a further variation, the CPO system 100 may score the likelihood of acceptability of each CPO, with different degrees of acceptability triggering different system responses. For example, a buyer who submits a statistically strong offer may receive an instant acceptance. In this embodiment, the operator of the CPO system 100 takes the economic risk of guaranteeing that the offer will be accepted by a seller. If the offer is ultimately not accepted by a seller, the CPO system 100 must generally pay the difference between the offer price and the market price in order to complete the transaction. Likewise, statistically weak offers may be (i) instantly rejected, (ii) returned for modification by the buyer, so that the modified CPO is more likely to be accepted by a seller, and/or (iii) subsidized by the CPO system 100 in order to make them more likely to be accepted.

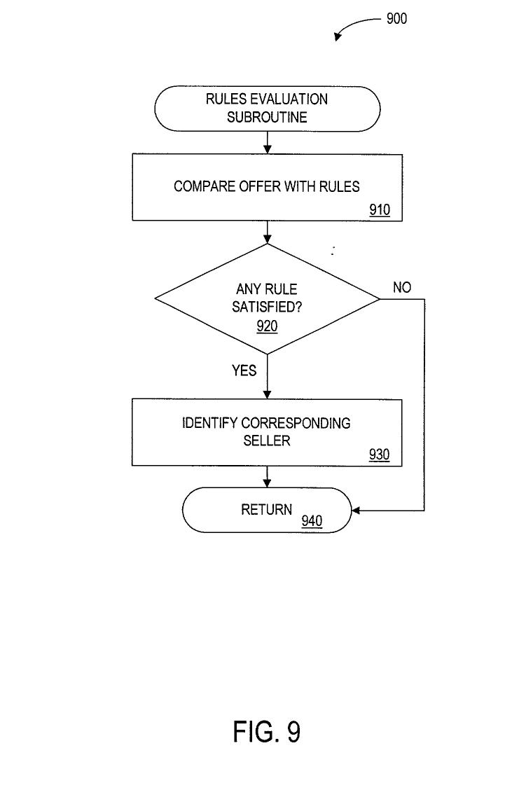

As previously indicated, the CPO evaluation process 800, shown in FIG. 8, provides each CPO that remains after pre-processing to the appropriate broadcast-based sellers, evaluates each CPO against the appropriate rules of each agency-based seller, and determines whether any sellers 130, 140, 150 accept the CPO. As illustrated in FIG. 8, the CPO evaluation process 800 initially transmits the CPO offer signal to broadcast-based sellers and executes the rules evaluation subroutine 900, discussed below in conjunction with FIG. 9, for agency-based sellers during step 810.

Since the CPO has been pre-screened, it is expected that at least one acceptance signal is received from one or more sellers during step 820. Thereafter, the CPO evaluation process 800 selects one accepting seller during step 830 and notifies the corresponding seller during step 840. For example, the accepting seller can be selected based upon (i) the priority in which the acceptances are received, (ii) the CPO acceptance rate of each seller, (iii) priorities negotiated by each seller, (iv) the acceptance providing the lowest cost to the buyer, or (v) the highest commission rates paid by the seller to the CPO system 100.

The buyer's personal information is provided to the seller during step 845 and the buyer is notified of the acceptance. The offer database 500 is updated during step 850 to indicate that the offer was accepted. A test is then performed during step 860 to determine if the buyer reneges on consummating the transaction. If it is determined during step 860 that the buyer reneges on consummating the transaction, then a penalty is charged to the buyer's designated general-purpose account during step 870, before program control terminates during step 880. It is noted that for a nonbinding CPO the buyer may be charged a penalty for failing to complete the transaction in the event the CPO is accepted, as described. For a binding CPO, however, the CPO is guaranteed by the general purpose account and it is not possible for the buyer to renege. If, however, it is determined during step 860 that the buyer does not renege on consummating the transaction, then program control terminates during step 880.

As previously indicated, the CPO evaluation process 800 executes a rules evaluation subroutine 900 during step 810 to determine if one or more agency-based sellers are willing to accept a given CPO. As shown in FIG. 9, the rules evaluation subroutine 900 compares the terms associated with the CPO during step 910 with the corresponding restrictions set forth in any CPO rules defined by any agency-based seller. A test is then performed during step 920 to determine if any CPO rule is satisfied. If it is determined during step 920 that no CPO rule is satisfied, then program control terminates during step 940. If, however, it is determined during step 920 that a CPO rule is satisfied, the corresponding seller is identified during step 930, before program control returns to the CPO evaluation process 800 during step 940.

In summary, the present invention identifies unacceptable conditional purchase offers and permits a buyer to revise and resubmit the conditional purchase offer to a modified conditional purchase offer that is more likely to be accepted. Furthermore, buyers can avoid the frustration accompanying a delayed rejection or expiration of an unacceptable conditional purchase offer. Likewise, sellers avoid wasting the resources associated with processing and reviewing unacceptable conditional purchase offers.

It is to be understood that the embodiments and variations shown and described herein are merely illustrative of the principles of this invention and that various modifications may be implemented by those skilled in the art without departing from the scope and spirit of the invention.

We claim:

1. A method for processing the sale of a product, comprising the steps of:
receiving a conditional purchase offer from a buyer for said product, said conditional purchase offer containing at least one buyer-defined condition;
determining if said conditional purchase offer satisfies predefined filtering criteria; and
processing said conditional purchase offer if said determining step determines that said conditional purchase offer satisfies said predefined filtering criteria.

2. The method according to claim 1, further comprising the step of providing a rejection to said buyer if said determining step determines that said conditional purchase offer does not satisfy said predefined filtering criteria.

3. The method according to claim 1, wherein said predefined filtering criteria determines if said conditional purchase offer is likely to be accepted by one or more potential sellers of said product.

4. The method according to claim 1, wherein said predefined filtering criteria determines if said conditional purchase offer provides a predefined margin of profit.

5. The method according to claim 1, wherein said processing step comprises the step of providing said conditional purchase offer to a plurality of potential sellers of said product.

6. The method according to claim 1, wherein said processing step comprises the step of identifying one or more rules from a plurality of potential sellers, each of said rules containing one or more seller-defined restrictions.

7. The method according to claim 1, wherein said determining step compares said conditional purchase offer to historical conditional purchase offer data.

8. The method according to claim 1, wherein said determining step considers a demand forecast.

9. The method according to claim 1, wherein said determining step compares said conditional purchase offer to retail pricing information.

10. The method according to claim 1, further comprising the step of subsidizing said conditional purchase offer if said determining step determines that said conditional purchase offer is not likely to be accepted.

11. The method according to claim 1, wherein said conditional purchase offer further includes a payment identifier for specifying an account from which funds may be paid.

12. The method according to claim 1, further comprising the step of initiating the use of said payment identifier if said customer does not complete said sale.

13. The method according to claim 11, wherein said funds may be paid from a general-purpose account.

14. The method according to claim 13, wherein said general-purpose account is a credit card account.

15. The method according to claim 1, wherein said conditional purchase offer is a binding conditional purchase offer.

16. The method according to claim 1, wherein said conditional purchase offer includes a variable condition.

17. The method according to claim 1, further comprising the step of preventing said customer from identifying an acceptable seller price.

18. The method according to claim 17, wherein said step of preventing said customer from identifying said acceptable seller price comprises the step of requiring said buyer to submit a binding conditional purchase offer.

19. The method according to claim 17, wherein said step of preventing said customer from identifying said acceptable seller price comprises the step of preventing said buyer from submitting multiple substantially similar conditional purchase offers.

20. The method according to claim 1, further comprising the step of maintaining the anonymity of said seller until said conditional purchase offer is accepted.

21. A method for processing the sale of a product, comprising the steps of:
receiving a conditional purchase offer from a buyer for said product, said conditional purchase offer containing at least one buyer-defined condition;
determining if said conditional purchase offer satisfies predefined filtering criteria; and
providing said conditional purchase offer to a plurality of potential sellers of said product if said determining step determines that said conditional purchase offer satisfies said predefined filtering criteria.

22. The method according to claim 21, further comprising the step of receiving from one or more of said sellers an acceptance of said conditional purchase offer.

23. The method according to claim 21, further comprising the step of binding said buyer to complete said sale if an acceptance is received for said conditional purchase offer.

24. The method according to claim 21, wherein said predefined filtering criteria determines if said conditional purchase offer is likely to be accepted by one or more of said sellers.

25. The method according to claim 24, wherein said conditional purchase offer is compared to historical conditional purchase offer data.

26. The method according to claim 24, wherein said conditional purchase offer is compared to a demand forecast.

27. The method according to claim 24, wherein said conditional purchase offer is compared to retail pricing information.

28. The method according to claim 21, wherein said predefined filtering criteria determines if said conditional purchase offer provides a predefined margin of profit.

29. The method according to claim 1, wherein said conditional purchase offer further includes a payment identifier for specifying an account from which funds may be paid.

30. A method for processing the sale of a product, comprising the steps of:
receiving a conditional purchase offer from a buyer for said product, said conditional purchase offer containing at least one buyer-defined condition;
determining if said conditional purchase offer is likely to be accepted by one or more potential sellers of said product; and
providing said conditional purchase offer to a plurality of potential sellers of said product if said determining step determines that said conditional purchase offer is likely to be accepted.

31. The method according to claim 30, further comprising the step of receiving from one or more of said sellers an acceptance of said conditional purchase offer.

32. The method according to claim 30, further comprising the step of binding said buyer to complete said sale if an acceptance is received for said conditional purchase offer.

33. The method according to claim 30, wherein said determining step compares said conditional purchase offer to historical conditional purchase offer data.

34. The method according to claim 30, wherein said determining step considers a demand forecast.

35. The method according to claim 30, wherein said determining step compares said conditional purchase offer to retail pricing information.

36. A method for processing the sale of a product, comprising the steps of:
receiving a conditional purchase offer from a buyer for said product, said conditional purchase offer containing at least one buyer-defined condition;
determining if said conditional purchase offer satisfies predefined filtering criteria; and
identifying one or more rules from a plurality of potential sellers, each of said rules containing one or more seller-defined restrictions if said determining step determines that said conditional purchase offer satisfies said predefined filtering criteria.

37. The method according to claim 36, further comprising the step of binding said buyer to complete said sale if said buyer-defined condition satisfies each of said seller-defined restrictions of at least one of said rules.

38. The method according to claim 36, wherein said predefined filtering criteria determines if said conditional purchase offer is likely to be accepted by one or more of said sellers.

39. The method according to claim 38, wherein said conditional purchase offer is compared to historical conditional purchase offer data.

40. The method according to claim 38, wherein said conditional purchase offer is compared to a demand forecast.

41. The method according to claim 38, wherein said conditional purchase offer is compared to retail pricing information.

42. The method according to claim 36, wherein said predefined filtering criteria determines if said conditional purchase offer provides a predefined margin of profit.

43. The method according to claim 36, wherein said conditional purchase offer further includes a payment identifier for specifying an account from which funds may be paid.

44. A method for processing the sale of a product, comprising the steps of:
receiving a conditional purchase offer from a buyer for said product, said conditional purchase offer containing at least one buyer-defined condition;
determining if said conditional purchase offer is likely to be accepted by one or more potential sellers of said product; and
identifying one or more rules from a plurality of potential sellers, each of said rules containing one or more seller-defined restrictions if said determining step determines that said conditional purchase offer is likely to be accepted.

45. The method according to claim 44, further comprising the step of binding said buyer to complete said sale if said buyer-defined condition satisfies each of said seller-defined restrictions of at least one of said rules.

46. The method according to claim 44, wherein said determining step compares said conditional purchase offer to historical conditional purchase offer data.

47. The method according to claim 44, wherein said determining step considers a demand forecast.

48. The method according to claim 44, wherein said determining step compares said conditional purchase offer to retail pricing information.

49. A system for processing the sale of a product, comprising:
input means for receiving a conditional purchase offer from a buyer for said product, said conditional purchase offer containing at least one buyer-defined condition;
a processor operatively coupled to said input means, said processor configured to:
determine if said conditional purchase offer satisfies predefined filtering criteria; and
process said conditional purchase offer if said determining step determines that said conditional purchase offer satisfies said predefined filtering criteria.

50. An article of manufacture comprising:
a computer readable medium having computer readable code means embodied thereon, said computer readable program code means comprising:
a step to receive a conditional purchase offer from a buyer for said product, said conditional purchase offer containing at least one buyer-defined condition;
a step to determine if said conditional purchase offer satisfies predefined filtering criteria; and
a step to process said conditional purchase offer if said determining step determines that said conditional purchase offer satisfies said predefined filtering criteria.

51. A system for processing the sale of a product, comprising:
input means for receiving a conditional purchase offer from a buyer for said product, said conditional purchase offer containing at least one buyer-defined condition;
a processor operatively coupled to said input means, said processor configured to:
determine if said conditional purchase offer satisfies predefined filtering criteria; and
provide said conditional purchase offer to a plurality of potential sellers of said product if said determining step determines that said conditional purchase offer satisfies said predefined filtering criteria.

52. An article of manufacture comprising:
a computer readable medium having computer readable code means embodied thereon, said computer readable program code means comprising:
a step to receive a conditional purchase offer from a buyer for said product, said conditional purchase offer containing at least one buyer-defined condition;
a step to determine if said conditional purchase offer satisfies- predefined filtering criteria; and
a step to provide said conditional purchase offer to a plurality of potential sellers of said product if said determining step determines that said conditional purchase offer satisfies said predefined filtering criteria.

53. A system for processing the sale of a product, comprising:
input means for receiving a conditional purchase offer from a buyer for said product, said conditional purchase offer containing at least one buyer-defined condition;
a processor operatively coupled to said input means, said processor configured to:
determine if said conditional purchase offer is likely to be accepted by one or more potential sellers of said product; and
provide said conditional purchase offer to a plurality of potential sellers of said product if said determining step determines that said conditional purchase offer is likely to be accepted.

54. An article of manufacture comprising:
a computer readable medium having computer readable code means embodied thereon, said computer readable program code means comprising:
a step to receive a conditional purchase offer from a buyer for said product, said conditional purchase offer containing at least one buyer-defined condition;
a step to determine if said conditional purchase offer is likely to be accepted by one or more potential sellers of said product; and
a step to provide said conditional purchase offer to a plurality of potential sellers of said product if said determining step determines that said conditional purchase offer is likely to be accepted.

55. A system for processing the sale of a product, comprising:
input means for receiving a conditional purchase offer from a buyer for said product, said conditional purchase offer containing at least one buyer-defined condition;
a processor operatively coupled to said input means, said processor configured to:
determine if said conditional purchase offer satisfies predefined filtering criteria; and
identify one or more rules from a plurality of potential sellers, each of said rules containing one or more seller-defined restrictions if said determining step determines that said conditional purchase offer satisfies said predefined filtering criteria.

56. An article of manufacture comprising:
a computer readable medium having computer readable code means embodied thereon, said computer readable program code means comprising:
a step to receive a conditional purchase offer from a buyer for said product, said conditional purchase offer containing at least one buyer-defined condition;
a step to determine if said conditional purchase offer satisfies predefined filtering criteria; and
a step to identify one or more rules from a plurality of potential sellers, each of said rules containing one or more seller-defined restrictions if said determining step determines that said conditional purchase offer satisfies said predefined filtering criteria.

57. A system for processing the sale of a product, comprising:
input means for receiving a conditional purchase offer from a buyer for said product, said conditional purchase offer containing at least one buyer-defined condition;
a processor operatively coupled to said input means, said processor configured to:
determine if said conditional purchase offer is likely to be accepted by one or more potential sellers of said product; and
identify one or more rules from a plurality of potential sellers, each of said rules containing one or more seller-defined restrictions if said determining step determines that said conditional purchase offer is likely to be accepted.

58. An article of manufacture comprising:
a computer readable medium having computer readable code means embodied thereon, said computer readable program code means comprising:
a step to receive a conditional purchase offer from a buyer for said product, said conditional purchase offer containing at least one buyer-defined condition;
a step to determine if said conditional purchase offer is likely to be accepted by one or more potential sellers of said product; and
a step to identify one or more rules from a plurality of potential sellers, each of said rules containing one or more seller-defined restrictions if said determining step determines that said conditional purchase offer is likely to be accepted.
